(19) United States
(12) Patent Application Publication
(10) Pub. No.: US 2010/0056195 A1
(43) Pub. Date: Mar. 4, 2010

(54) METHOD AND SYSTEM FOR COMMUNICATING BETWEEN A VEHICLE AND A CALL CENTER

(75) Inventor: Timothy R. Nixon, Northville, MI (US)

Correspondence Address: Julia Church Dierker;Dierker & Associates, P.C., 3331 W. Big Beaver Road, Suite 109, Troy, MI, 48084-2813, US

(73) Assignee: GENERAL MOTORS CORPORATION, Detroit, MI (US)

(21) Appl. No.: 12/202,217

(22) Filed: Aug. 29, 2008

(51) Int. Cl. H04B 7/00

(52) U.S. Cl. 455/518

(57) ABSTRACT

A method of communicating between a vehicle and a call center includes establishing voice communication between a telematics unit of the vehicle and the call center; verbally communicating data during the voice communication; and designating, via an advisor at the call center, at least some of the verbally communicated data as significant data during a data entry mode of an operator station. Textual and/or graphical indicia corresponding to the significant data are sent from the call center to an in-vehicle display unit. The method further includes displaying the indicia on the in-vehicle display unit; determining whether the displayed indicia accurately correspond with the significant data; and confirming whether or not the displayed indicia accurately correspond with the significant data in response to one of (a) a signal from the telematics unit, or (b) an input by the call center advisor. A system incorporating the method is also disclosed herein.

### TECHNICAL FIELD

The present disclosure relates generally to methods and systems for communicating between a vehicle and a call center.

### BACKGROUND

Many vehicles are currently equipped with communication devices allowing an operator or other occupant of the vehicle to communicate with a service or call center. For example, the in-vehicle communication device (such as, e.g., a telematics unit) may be used to establish a connection with the call center in order to obtain information and/or services from the call center, as well as to provide information to the call center. In some instances, the information and/or services obtained from the call center or the information provided to the call center includes significant data, the accuracy of which may, and in some cases should, be confirmed by the vehicle operator or occupant. Currently, such confirmation may be accomplished by 1) verbally repeating the significant data to the operator or occupant of the vehicle, and then 2) the operator or occupant verbally confirming the accuracy of the data to the call center.

### SUMMARY

A method for communicating between a vehicle and a call center is disclosed herein. The method includes establishing a voice communication between a telematics unit of the vehicle and the call center, and during the voice communication, verbally communicating data. The method further includes designating, via an advisor at the call center, at least some of the verbally communicated data as significant data during a data entry mode of an operator station. The indicia corresponding to the significant data are sent, from the call center to an in-vehicle display unit of the vehicle, the indicia including at least one of textual indicia or graphical indicia. The indicia are displayed on the in-vehicle display system, and a determination is made as to whether the displayed indicia accurately correspond with the significant data. The method also includes confirming whether or not the displayed indicia accurately correspond with the significant data in response to one of (a) a signal from the telematics unit, or (b) an input by the call center advisor. Also disclosed herein is a system incorporating the method.

### BRIEF DESCRIPTION OF THE DRAWINGS

Features and advantages of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a system for communicating between a vehicle and a call center;

FIG. 2 is a flow diagram depicting an example of the method for communicating between the vehicle and the call center; and

FIG. 3 is a flow diagram depicting another example of the method for communicating between the vehicle and the call center.

### DETAILED DESCRIPTION

Examples of the method and system disclosed herein advantageously display indicia corresponding with significant data recited in a verbal conversation between a user of a vehicle and an advisor at a call center on an in-vehicle display unit for viewing by the user. The user may confirm the accuracy of the indicia and, therefore, the accuracy of the significant data verbally recited in the conversation. Confirmation of the significant data recited in the conversation substantially reduces confusion between the user and the advisor and/or misunderstanding of the significant data on the part of the advisor due to, for example, a poor wireless connection between the vehicle and the call center. The method and system disclosed herein further advantageously reduce the vehicle's calling time with the call center and improve the accuracy of the exchange of data between the vehicle and the call center.

It is to be understood that, as used herein, the term “user” includes vehicle owners, operators, occupants, and/or passengers. It is to be further understood that the term “user” may be used interchangeably with subscriber/service subscriber.

The terms “connect/connected/connection,” “couple/coupled,” and/or the like are broadly defined herein to encompass a variety of divergent connected or coupled arrangements and assembly techniques. These arrangements and techniques include, but are not limited to (1) the direct communication between one component and another component with no intervening components therebetween; and (2) the communication of one component and another component with one or more components therebetween, provided that the one component being “connected to” or “coupled to” the other component is somehow in operative communication with the other component (notwithstanding the presence of one or more additional components therebetween).

It is to be further understood that the terms “communication” and “communicating” are to be construed to include all forms of communication and communicating, respectively, including direct and indirect communication. As such, indirect communication may include communication between two components with additional component(s) located therebetween.

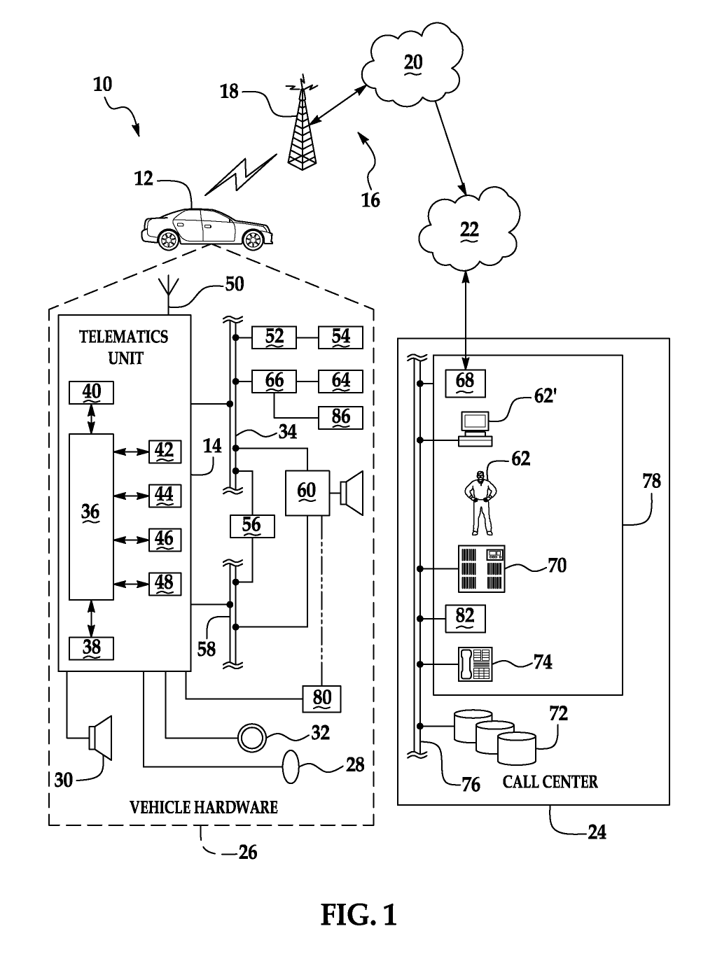

Referring now to FIG. 1, the system 10 includes a vehicle 12, a telematics unit 14, a wireless carrier/communication system 16 (including, but not limited to, one or more cell towers 18 and/or one or more base stations and/or mobile switching centers (MSCs) 20, which are generally owned and/or operated by one or more cellular service providers (not shown)), one or more land networks 22, and one or more call centers 24. In an example, the wireless carrier/communication system 16 is a two-way radio frequency communication system.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicle 12 is a mobile vehicle such as a motorcycle, car, truck, recreational vehicle (RV), boat, plane, etc., and is equipped with suitable hardware and software that enables it to communicate (e.g., transmit and/or receive voice and data communications) over the wireless carrier/communication system 16. As will be described in further detail below, the telematics unit 14 may be used for communicating voice and data communications with a call center 24. It is to be understood that the vehicle 12 may also include additional components suitable for use in the telematics unit 14.

Some of the vehicle hardware 26 is shown generally in FIG. 1, including the telematics unit 14 and other components that are operatively connected to the telematics unit 14. Examples of such other hardware 26 components include a microphone 28, a speaker 30, and buttons, knobs, switches, keyboards, and/or controls 32. Generally, these hardware 26 components enable a user to communicate with the telematics unit 14 and any other system 10 components in communication with the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard device that provides a variety of services, both individually and through its communication with the call center 24. The telematics unit 14 generally includes an electronic processing device 36 operatively coupled to one or more types of electronic memory 3 8, a cellular chipset/component 40, a wireless modem 42, a navigation unit containing a location detection (e.g., global positioning system (GPS)) chipset/component 44, a real-time clock (RTC) 46, the previously mentioned short-range wireless communication network 48 (e.g., a Bluetooth® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the short-range wireless communication network 48. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 44 may include a Global Position System (GPS) receiver, a radio triangulation system, a dead reckoning position system, and/or combinations thereof In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone. The cellular chipset-component 40 uses one or more prescribed frequencies in the 800 MHz analog band or in the 800 MHz, 900 MHz, 1900 MHz and higher digital cellular bands. Any suitable protocol may be used, including digital transmission technologies such as TDMA (time division multiple access), CDMA (code division multiple access) and GSM (global system for mobile telecommunications). In some instances, the protocol may be short-range wireless communication technologies, such as Bluetooth®, dedicated short-range communications (DSRC), or Wi-Fi.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services, some of which may not be listed herein. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

Vehicle communications preferably use radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the vehicle occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services.

The audio component 60 is operatively connected to the vehicle bus 34 and the audio bus 58. The audio component 60 receives analog information, rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, and/or the like. Non-limiting example sensor interface modules 66 include powertrain control, climate control, body control, and/or the like.

The vehicle 12 further includes an in-vehicle motion sensor 86 operatively connected to the vehicle bus 34 (e.g., via a sensor interface module 66). The motion sensor 86 is generally configured to detect whether or not the vehicle 12 is in motion and to generate a signal indicating the same. Such signals may be transmitted internally from the bus 34 to the processing device 36 of the telematics unit 14. Such signals may be used by the processing device 36 to determine whether or not to present indicia (discussed further hereinbelow) received by the call center 24 to the in-vehicle user. As an example, the processing device 36 may be configured to prevent such indicia from being displayed in the vehicle 12 while a signal indicating that the vehicle 12 is in motion is being received. As another example, the processing device 36 may be configured to allow the presentation of received indicia regardless of whether the vehicle 12 is moving or not moving. The processing device 36 configurations may be set by the manufacturer, and altered, for example, remotely via the call center 24 upon its own initiative or in response to a request from the user.

In a non-limiting example, the vehicle hardware 26 includes the in-vehicle display unit (also referred to herein as the “display”) 80, which may be operatively connected or coupled to the telematics unit 14 directly, or may be part of the audio component 60. Non-limiting examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Display), and/or the like. As will be described further herein, the display 80 may be used to present received indicia to the vehicle user(s).

Wireless carrier/communication system 16 may be a cellular telephone system or any other suitable wireless system that transmits signals between the vehicle hardware 26 and land network 22. According to an example, wireless carrier/communication system 16 includes one or more cell towers 18, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

Land network 22 may be a conventional land-based telecommunications network that is connected to one or more landline telephones and connects wireless carrier/communication network 16 to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof.

Call center 24 is designed to provide the vehicle hardware 26 with a number of different system back-end functions. According to the example shown here, the call center 24 generally includes a call servicing system 78 for servicing calls from one or more vehicles, including vehicle 12. The call servicing system 78 includes one or more switches 68 and servers 70, in addition to the live and/or automated advisors 62, 62′. The call servicing system 78 further includes an operator station 82 for 1) receiving data (which may be stored in a subscriber/user personal profile in databases 72) entered by the live and/or automated advisors 62, 62′, and 2) for enabling, in conjunction with other components of the system 78, voice and data communication with the telematics unit 14. Data entry into the station 82 (which, as previously mentioned, may be saved in the databases 72) is accomplished during a data entry mode. The data entry mode includes at least a data entry operation, a significant data selection operation, a data communication operation, and a significant data confirmation operation. These various operations of the data entry mode will be described further in conjunction with examples of the method disclosed below.

It is to be understood that the components of the call servicing system 78 work together to service calls from subscriber and/or potential subscriber vehicles 12. In some instances all of the components may be utilized to service a call, and in other instances, less than all of the components may be utilized to service calls. Furthermore, while the database 72 is shown as being outside of the call servicing system 78, it is to be understood that one or more of the components of the system 78 may access the database(s) 72 to assist in servicing calls.

The call center 24 further includes a variety of other telecommunication and computer equipment 74 that is known to those skilled in the art. The various components of the call servicing system 78, as well as the call center 24, are each coupled to one another via a network connection or bus 76, such as the one (vehicle bus 34) previously described in connection with the vehicle hardware 26.

The live advisor 62 may be physically present at the call center 24 or may be located remote from the call center 24 while communicating therethrough.

Switch 68, which may be a private branch exchange (PBX) switch, routes incoming signals so that voice transmissions are usually sent to either the live advisor 62 or an automated response system 62′, and data transmissions are passed on to a modem or other piece of equipment (not shown) for demodulation and further signal processing. The modem preferably includes an encoder, as previously explained, and can be connected to various devices such as the server 70 and database 72. For example, database 72 may be designed to store subscriber profile records, subscriber behavioral patterns, or any other pertinent subscriber information. Although the illustrated example has been described as it would be used in conjunction with a manned call center 24, it is to be appreciated that the call center 24 may be any central or remote facility, manned or unmanned, mobile or fixed, to or from which it is desirable to exchange voice and data communications.

It is to be understood that, although a cellular service provider (not shown) may be located at the call center 24, the call center 24 is a separate and distinct entity from the cellular service provider. In an example, the cellular service provider is located remote from the call center 24. A cellular service provider generally provides the user with telephone and/or Internet services. The cellular service provider is generally a wireless carrier (such as, for example, Verizon Wireless®, AT&T®, Sprint®, etc.). It is to be understood that the cellular service provider may interact with the call center 24 to provide service(s) to the user.

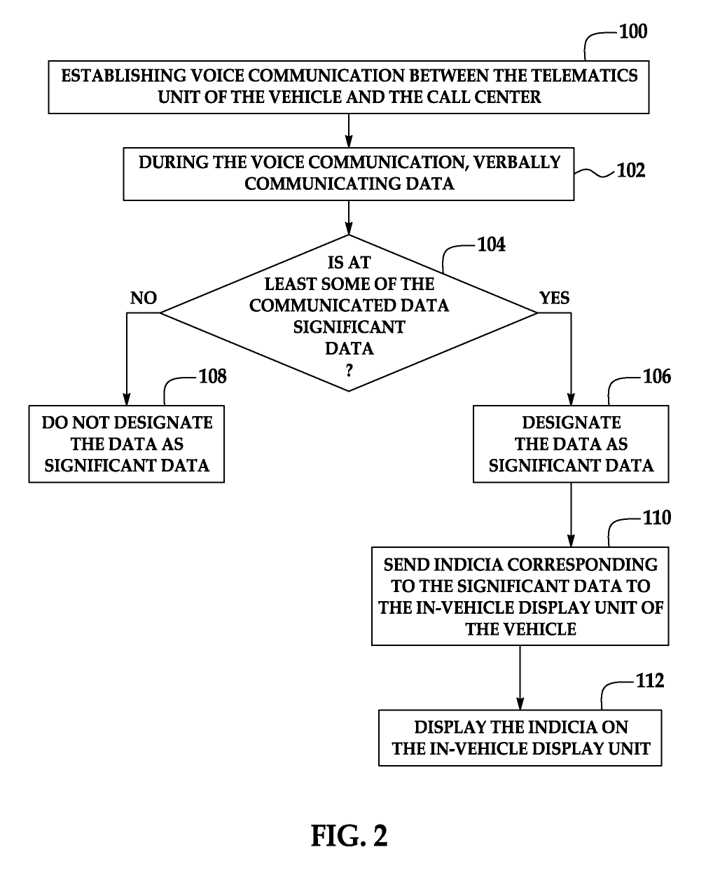

An example of the method for communicating between the vehicle 12 and the call center 24 is generally depicted in FIG. 2. The method begins by establishing a voice communication between the telematics unit 14 of the vehicle 12 and the call center 24 (as shown by reference numeral 100). In an example, the voice communication is initiated by the user of the vehicle 12 using the telematics unit 14. For example, the user may physically initiate such communication. Such physical initiation may be accomplished via a button press, touch screen, or the like located in the vehicle 12. It is to be understood that the button press or touch screen is operatively connected to the telematics unit 14. Upon the user's initiation of the button press or touch screen, the telematics unit 14 signals the call center 24 of the fact that the user has initiated a request. At the call center 24, the switch 68 directs the user to the live or automated advisor 62, 62′ at the call servicing system 78. In another example, the voice communication is established by the live or automated advisor 62, 62′ at the call servicing system 78 by contacting the telematics unit 14 of the vehicle 12.

In some instances, prior to establishing the voice communication between the user and the call center 24, the user may be authenticated by the advisor 62, 62′. Authentication may be accomplished by providing, by the user, correct personal information associated with one or more prescribed challenges. As one example, the user may be asked to supply his/her username and pass word. In another example, the prescribed challenge(s) may include a question or request for information relating to personal information of the user, such as, e.g., “What is your mother's maiden name?”, “What was the name of your first pet?”, “Describe the color of your first car,” and/or the like. The answers to these questions or requests (i.e., the personal data) are originally answered by the user and are stored in a user's profile record. If the user provides the accurate username and password and/or answers the questions or requests correctly, the user will be authenticated and data may then be exchanged between the user and the advisor 62, 62′.

During the voice communication, data is verbally communicated between the live advisor 62 or the automated advisor 62′ (e.g., an interactive voice recognition system (IVR)) and the user (as shown by reference numeral 102). It is to be understood that verbal utterances of either the live advisor 62 or the automated advisor 62′ and/or the user may contain data. Non-limiting examples of the data received by the advisor 62, 62′ from the user include a verbal request for data (e.g., a phone number stored in the user's personal profile) from the call center 24, a verbal request for a service (e.g., navigation instructions) from the call center 24, a verbal submission of data previously requested by the call center 24 (e.g., a user's new garage address), or the like. As previously mentioned, the data may also be communicated to the user from the advisor 62, 62′. For example, during the voice communication, either advisor 62 or 62′ may verbally transmit data (e.g., navigation instructions) to the user of the vehicle 12. While examples of the verbally communicated data are discussed herein, it is to be understood that other types of data may also be verbally communicated between the user and the call center advisor 62, 62′.

The data exchanged between the user and the advisor 62, 62′ during the voice communication may, in some cases, include significant data. As used herein, the term “significant data” refers to 1) information that is considered to have at least some level of importance or significance, 2) a type of information that would generally entail a confirmation of its accuracy, and/or 3) information that includes complex data that may be relatively difficult to verbally convey because of the nature of the data (e.g., letters of a word that sound like an “e”, but are not spelled with an “e”, for example, the “i” in Leigh street), etc. Such information may include, for example, a person's name, a business name, a phone number, a mailing address (or a portion thereof), an e-mail address, and/or the like. Significant data may further include confidential information pertaining the user's account such as a log in ID, a password, a number of purchased minutes used, a number of purchased minutes, a bill balance, a user's payment information (e.g., credit card number), and/or the like. Yet other examples of significant data may include services requested by the user such as a destination route, the location of a specified geographic area, a point of interest, and/or the like. When a navigation route is requested, significant data may include the destination, major route maneuvers or other attributes (e.g., waypoints), or the like. It is further to be understood that the examples listed above are not intended to be limiting herein and that many other non-listed examples may also qualify as significant data.

Furthermore, significant data may be selected by the user (e.g., by asking the live advisor 62 or automated advisor 62′ to repeat or verify the accuracy of the information), or by the live advisor 62 or automated advisor 62′ (e.g., by asking the user to confirm that certain information is accurate). In an example, during the voice communication, the advisor 62, 62′ at the call center 24 may inquire as to whether or not at least some of the data communicated is significant data or the user may inform the advisor that he/she deems some of the data significant (both of which are represented by reference numeral 104). If it is determined that some or all of the data is significant, the advisor 62, 62′ designates the data as significant data (as shown by reference numeral 106). If it is determined that none of the data is considered to be significant, the advisor 62, 62′ does not designate any of the data as significant data (as shown by reference numeral 108). As an example, during the voice communication, the user verbally submits his/her e-mail address to the advisor 62, 62′ and indicates that the e-mail address may be used for bill payment confirmation. The advisor 62, 62′ may designate the recitation of the e-mail address as significant data, while the advisor 62, 62′ may not designate the recitation that the e-mail address may be used for bill payment confirmation as significant data. The designation of significant data may simply be the verbal recognition of such significance by the advisor 62, 62′. Furthermore, data that is not designated as being significant may simply be listened to, without any acknowledgment as to whether the information is significant or insignificant. Once the advisor 62, 62′ has designated the desirable verbal data as significant, the designated data is entered into the operator station 82.

Significant data entry occurs during the significant data selection operation of the data entry mode (as also referred to above in conjunction with FIG. 1). In instances where verbal communication is established between the user and the live advisor 62, the live advisor 62 manually enters the designated data into the operator station 82 (for example, by typing the data into the operator station 82 using, e.g., a keyboard or a touch screen) or transfers such data from the database 72 or other application including such data therein. This data is used to create the indicia, which is ultimately output as indicia to the user's display unit 80 (as described in further detail below). In instances where verbal communication is established between the user and the automated advisor 62′, the automated advisor 62′ automatically translates the designated data (e.g., a user input request) into the indicia. This translated data is then sent from the automated computer equipment to the vehicle's display unit 80.

After the advisor 62, 62′ has input the significant data, the advisor 62, 62′ sends indicia corresponding to the significant data to the in-vehicle display 80 of the vehicle 12 (as shown by reference numeral 110). The advisor 62, 62′ generates the indicia from the input data. As such, the indicia may be textual indicia, graphical indicia, or a combination of both. In some instances, the indicia include exactly what the advisor 62, 62′ inputs as significant data (i.e., text/graphics as they were entered). In other instances, the indicia include additional text or graphics that accompany the original data input by the advisor 62, 62′ and based on the designated significant data. Examples of such graphics may include icons, logos, small maps, or the like. The additional text or graphics may be used to enhance the delivery of services or the conveyance of the significant information. As one example, if the significant information is an address, a map of the area surrounding the address may enhance the conveyance of the information. As another example, if the significant information is navigation instructions, symbols indicating the direction of a turn may enhance the delivery of the instructions.

Sending the indicia generally occurs during the data communication operation of the data entry mode. With reference to the example provided above, the advisor 62, 62′ sends, to the display 80 in the user's vehicle 12, indicia corresponding to the e-mail address recited in the voice communication between the user and the advisor 62, 62′. In this example, the indicia may be a textual reiteration of the advisor's interpretation of the spoken e-mail address (e.g., “abc123@mail.com”), and is provided in a format suitable for viewing by the user of the vehicle 12. As previously mentioned, an icon or logo such as, e.g., an envelope or other symbol representing electronic mail, may accompany the textual indicia. In this particular example, the textual indicia is the e-mail information that is input by the advisor 62, 62′ that is supposed to correspond with the e-mail address verbally supplied by the user.

In an example, the indicia are sent from the call center 24 to the processing device 36 of the telematics unit 14. The telematics unit 14 then displays the indicia to the user via the display unit 80. It is to be understood that any suitable connection/transmission technology may be used to send or transmit the indicia from the call center 24 to the vehicle 12. In a non-limiting example, the indicia are sent via a circuit switch call using an in-band modem. In another non-limiting example, the indicia are sent via a packet data call using at least one of an air interface protocol (AIP) or a web service description language. In yet another non-limiting example, the indicia are sent via an SMS message to the telematics unit 14 to exchange data independent of a circuit or packet switched call. Alternatively, the data may be sent via a Bluetooth®, Wi-Fi, Wi-MAX, or the like.

Prior to sending the indicia, the call center 24 may also transmit a message to the in-vehicle user indicating that the indicia is ready for transmission to the vehicle 12. This may serve to notify the user to view the display 80, or to notify the user that he/she should indicate to the call center 24 when he/she is ready to receive the indicia.

It is to be understood that, in some instances, the indicia may not always be suitably formatted for viewing on the display unit 80. In these instances, prior to sending the indicia from the call center 24 to the vehicle 12, the call center 24 retrieves the capabilities of the display unit 80 and formats the indicia according to those capabilities. Such capabilities include the screen size, aspect ratio/resolution, color settings, font and font size, or the like. In an example, the capabilities of the display unit 80 are retrieved by the call center 24 by requesting such capabilities from the telematics unit 14 and sending the capabilities from the telematics unit 14 to the call center 24. In another example, the capabilities of the display unit 80 are retrieved, by the call center 24, by accessing a user profile stored at the call center 24 (e.g., in one of the databases 72). The user profile may include the display unit capabilities of one or more of the user's vehicles. The user profile may also include other information related to the user of the vehicle 12 and/or of the vehicle 12 itself.

Alternatively, prior to sending the indicia from the call center 24 to the vehicle 12, the telematics unit 14 retrieves the capabilities of the display unit 80 and formats the indicia according to those capabilities. In a non-limiting example, if the in-vehicle display unit 80 is a 12-bit character text display, the indicia may be formatted so that it includes 1) only 12 characters of text, or 2) more than 12 characters of text and a prompt for the user to scroll the text in order to display the indicia completely. In another non-limiting example, if the display 80 is configured as a graphical display, the indicia may be formatted so that graphics (e.g., icons, maps, or the like) are displayed in addition to or in place of the text.

Upon receiving the indicia from the call center 24, the telematics unit 14 (via the processor 36) displays the indicia on the display unit 80 (as shown by reference numeral 112). It is to be understood that, in some instances, it may not be desirable to display the indicia on the display unit 80 for viewing by the user of the vehicle 12 when the vehicle 12 is moving. In such instances, displaying the indicia to the user, when the user is actually operating the vehicle, may be distracting to the user, especially if relatively large amounts of information are included in the indicia. Accordingly, the telematics unit 14 may be configured to determine whether or not the vehicle 12 is moving by receiving a signal indicating the same from the in-vehicle motion sensor 86. If the vehicle is in fact moving, the telematics unit 14 may, if programmed to, instruct the display unit 80 to refrain from displaying the indicia or to display an abbreviated version of the data. In these instances, when the telematics unit 14 determines, again via a signal from the motion sensor 86, that the vehicle 12 is stopped or parked, the telematics unit 14 then instructs the display unit 80 to display the indicia.

In other instances, however, it may be desirable to actually display the indicia while the vehicle 12 is moving. For example, if the user requested a turn-by-turn route for a particular destination, it would be impractical to stop the vehicle 12 every time the user reviews the route for a particular turn along the route. Under these circumstances, the turn-by-turn route will be displayed on the display unit when the vehicle 12 is moving. It is to be understood that if the indicia is displayed on the display unit 80 when the vehicle 12 is moving, the indicia may, in some instances, be formatted differently (than it would be if the vehicle 12 were stopped) to allow the user to easily review the indicia while the user is operating the vehicle. In a non-limiting example, if the indicia include a navigation maneuver, rather than stating, “turn right on Maple Street”, the indicia may include a symbol indicating a right arrow and the word “Maple Street” underneath it.

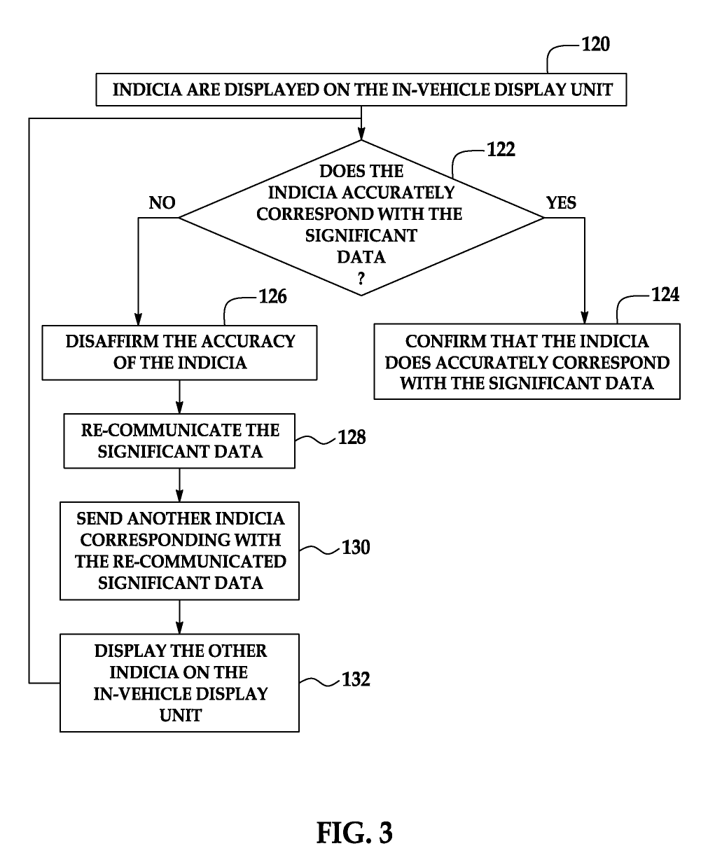

Once the indicia are displayed on the display unit 80, an example of the method also includes confirming that the displayed indicia accurately correspond with the significant data, as depicted in FIG. 3. In one non-limiting example, the indicia may include an e-mail address of the user, which the user may verify its accuracy. In another non-limiting example, the indicia may include a navigation route, which the user may verify the destination point and/or possibly major route maneuvers of the navigation instructions. These examples are meant to be non-limiting, and it is to be understood that other examples are contemplated as being within the scope of this disclosure.

The method depicted in FIG. 3 begins by displaying the indicia on the in-vehicle display unit 80 (as shown by reference numeral 120). After displaying the indicia, the call center 24 or the telematics unit 14 may inquire, from the user, whether or not the indicia accurately correspond with the significant data. Such inquiry may be made by either 1) a signal from the telematics unit 14, or 2) an input from the call center 24 (such as, e.g., a verbal inquiry asking the user if the indicia are accurate or a visual message that is sent from the call center 24 and is displayed on the display unit 80 asking if the indicia is accurate).

Upon visual inspection of the indicia displayed on the display unit 80, the user determines whether or not the indicia accurately correspond with the significant data (as shown by reference numeral 122). If, for example, the user determines that the indicia do accurately correspond with the significant data, the user will confirm the accuracy of the indicia (as shown by reference numeral 124). The confirmation may be accomplished by the user verbally reciting “yes” into the microphone 28 or pressing a button (e.g., button 32) representative of “yes”, or by other suitable means of inputting the user's confirmation response to the telematics unit 14. The telematics unit 14 ultimately sends the confirmation response to the call center 24. Based on the signal received from the telematics unit 14, the operator station 82 (during the significant data confirmation operation) may automatically save, or the advisor 62, 62′ (during the significant data confirmation operation of the operator station 82) may save the data that corresponds with the accurate indicia in the user's profile for later use.

In the event that the user determines that the indicia do not accurately correspond with the significant data, the user may disaffirm the accuracy of the indicia to the call center advisor 62, 62′ (as shown by reference numeral 126). The disaffirmation may be accomplished by the user verbally reciting “no” into the microphone 28 or pressing a button representative of “no”, or by other suitable means of inputting the user's disaffirmation response to the telematics unit 14, which ultimately sends the disaffirmation response to the call center 24. After disaffirming the accuracy of the indicia, the user may re-communicate the significant data to the advisor 62, 62′ (as shown by reference numeral 128). Re-communication may be accomplished by the user verbally reciting the significant data into the microphone 28. The call center advisor 62, 62′ receives the re-communicated significant data and generates new indicia corresponding with the re-communicated significant data. The advisor 62, 62′ thereafter sends the new indicia to the vehicle 12 (as shown by reference numeral 130), which is ultimately displayed on the in-vehicle display unit 80 (as shown by reference numeral 132). If the user thereafter determines that the new indicia still does not accurately correspond with the significant data, the method depicted in FIG. 3 may be repeated until the indicia accurately corresponds with the significant data.

While several examples have been described in detail, it will be apparent to those skilled in the art that the disclosed examples may be modified. Therefore, the foregoing description is to be considered exemplary rather than limiting.

1. A method for communicating between a vehicle and a call center, the method comprising:
establishing voice communication between a telematics unit of the vehicle and the call center;
during the voice communication, verbally communicating data;
designating, via an advisor at the call center, at least some of the verbally communicated data as significant data during a data entry mode of an operator station;
sending, from the call center to an in-vehicle display unit of the vehicle, indicia corresponding to the significant data, the indicia including at least one of textual indicia or graphical indicia;
displaying the indicia on the in-vehicle display unit;
determining whether the displayed indicia accurately correspond with the significant data; and
confirming whether or not the displayed indicia accurately correspond with the significant data in response to one of (a) a signal from the telematics unit or (b) an input by the call center advisor.

2. The method as defined in claim 1, further comprising:
determining whether the vehicle is moving; and
if the vehicle is moving, one of: refraining from displaying the indicia on the in-vehicle display unit, or displaying an indicia including an abbreviated version of the significant data.

3. The method as defined in claim 2, further comprising:
determining that the vehicle has stopped or parked; and
displaying the indicia on the in-vehicle display unit once the determination is made.

4. The method as defined in claim 2, further comprising transmitting a message to the vehicle indicating that the indicia is ready for transmission to the in-vehicle display unit.

5. The method as defined in claim 1 wherein prior to sending, the method further comprises:
retrieving in-vehicle display unit capabilities; and
formatting the indicia, at the call center, according to the in-vehicle display unit capabilities.

6. The method as defined in claim 5 wherein the retrieving of the in-vehicle display unit capabilities is accomplished by:
requesting, via the call center, the in-vehicle display unit capabilities from the telematics unit; and
sending, from the telematics unit to the call center, the in-vehicle display unit capabilities.

7. The method as defined in claim 5 wherein the retrieving of the in-vehicle display unit capabilities is accomplished by accessing a user profile stored at the call center, the user profile including the in-vehicle display unit capabilities.

8. The method as defined in claim 1, further comprising formatting the indicia, via the telematics unit, according to in-vehicle display unit capabilities.

9. The method as defined in claim 1 wherein if the indicia do not accurately correspond with the significant data, the method further comprises:
disaffirming the accuracy of the indicia to the advisor at the call center;
re-communicating the significant data;
sending, to the vehicle, an other indicia corresponding to the re-communicated significant data; and
displaying the other indicia on the in-vehicle display unit.

10. The method as defined in claim 1 wherein the verbally communicated significant data is communicated via an in-vehicle user input or via a call center advisor input.

11. A system for communicating between a vehicle and a call center, comprising:
a telematics unit, located in the vehicle, configured for voice and data communication with the call center;
an in-vehicle display unit coupled to the telematics unit; and
a call servicing system at the call center configured for servicing calls from the vehicle and for voice and data communication with the telematics unit, the system including at least one operator station for data entry by a call center advisor, the at least one operator station having a data entry mode including:
a data entry operation for receiving data entered by the call center advisor into the operator station;
a significant data selection operation for receiving a designation of significant data by the call center advisor;
a data communication operation for sending the significant data designated by the call center advisor for display by the in-vehicle display unit; and
a significant data confirmation operation, responsive to one of (a) a signal from the telematics unit or (b) an input by the call center advisor.

12. The system as defined in claim 11 wherein the significant data designated by the call center advisor for display by the in-vehicle display unit is at least one of textual or graphical indicia corresponding to the significant data.

13. The system as defined in claim 11, further comprising:
an in-vehicle motion sensor for determining whether or not the vehicle is moving; and
a processor, operatively connected to the in-vehicle motion sensor, for instructing the in-vehicle display unit to display the indicia if the vehicle is not moving.

14. The system as defined in claim 11 wherein the call center is configured to retrieve in-vehicle display unit capabilities, and wherein the system further comprises means for formatting the indicia, at the call center, according to the in-vehicle display unit capabilities.

15. The system as defined in claim 14 wherein the call center is further configured to retrieve the in-vehicle display unit capabilities from a user profile stored at the call center.

16. The system as defined in claim 14 wherein the call center is further configured to retrieve the in-vehicle display unit capabilities from the telematics unit.

17. The system as defined in claim 11, further comprising means, operatively connected to the telematics unit, for formatting the indicia according to in-vehicle display unit capabilities.

18. The system as defined in claim 11, further comprising means, in the vehicle, for determining whether the indicia accurately correspond with the significant data, and wherein the telematics unit is configured to send, to the significant data confirmation operation or to the call center advisor, the determination as a confirmation or a disaffirmation of the accuracy of the indicia.

19. The system as defined in claim 11 wherein the call center advisor is a live advisor or an automated advisor.
